(19) United States
(12) Patent Application Publication
(10) Pub. No.: US 2015/0362141 A1
(43) Pub. Date: Dec. 17, 2015

(54) Railless Frequency-Conversing Swing Device

(71) Applicant: Chao Hung Chen, Xihu Township (TW)

(72) Inventor: Chao Hung Chen, Xihu Township (TW)

(21) Appl. No.: 14/302,576

(22) Filed: Jun. 12, 2014

(51) Int. Cl. F21S 10/04; F21S 9/02; F21S 9/03

(52) U.S. Cl. CPC F21S 10/046; F21S 9/037; F21S 9/02; F21Y 2101/02

(57) ABSTRACT

A railless frequency-conversing swing device contains a swinging unit including a base, a support post, a sway member, and a connecting object. The support post includes a first segment and a second segment, and the first segment is vertically connected with the base, the second segment has a distal end in an acute angle shape. The sway member is a balance member and includes a concave cavity defined in a top end thereof to accommodate the support post and to be pushed by the detail end of the second segment of the support post, the sway member also includes a fixing portion formed on a top end thereof, the connecting object is replaceably fixed into the fixing portion of the sway member to swing with the sway member; and a light source is fixed on one side of the connecting object for illuminating lights to the connecting object.

### BACKGROUND OF THE INVENTION

1. Field of the Invention

The present invention relates to a swing device, and more particularly to a railless frequency-conversing swing device which produces flame-like effect.

2. Description of the Prior Art

A conventionally swingable adornment swings at single frequency or magnitude. But such a conventionally swingable adornment consumes power quickly and operates dully. To overcome such a problem, an improved adornment is improved, it swings at plural frequencies by ways of a program, however, its operating mode is still dull and has more electronic components to cause great power consumption.

In addition, a conventional kinetic flame device contains a circuit board for directly controlling coil to produce magnetic force at different intensities and to push a sway component inserted and hanged by a support element. Hence, the conventional kinetic flame device generates a similar swing effect blowing in a wind. Nevertheless, this conventional kinetic flame device is controlled by a program, so it includes more electronic components and consumes excessive power. Moreover, the sway component is inserted and hanged by the support element to have inconvenient assembly and unnatural swing.

The present invention has arisen to mitigate and/or obviate the afore-described disadvantages.

### SUMMARY OF THE INVENTION

The primary objective of the present invention is to provide a railless frequency-conversing swing device which captures optical signals at different strengths to control oscillating frequency, and a concave cavity is defined in a top end of a sway member to accommodate a support post and to be pushed by a detail end of a second segment of a support post, thus assembling the sway member easily. In addition, the sway member swings freely and smoothly at minimum friction by using magnetic force and physical inertia.

Another objective of the present invention is to provide a railless frequency-conversing swing device which contains a power unit, and at least one photoresistor of an optical signal apparatus of a power unit receives irregular lights from at least one illumining member and generates different signals to control magnetic fields at different strengths so as to further push a permanent magnet on the sway member, and the sway member swings at different amplitudes and frequencies. In other words, by using magnetic theory, physics friction theorem and simplified electronic circuits, the sway member swings at changeable oscillating frequencies, thus changing oscillating frequencies, simplifying electronic components, avoiding consumption of electric circuit, lowering power consumption, and eliminating inconvenience of battery replacement.

To obtain the above objectives, a railless frequency-conversing swing device provided by the present invention contains: a swinging unit including a base, a support post, a sway member, and a connecting object.

The support post includes a first segment and a second segment, and the first segment is vertically connected with the base, the second segment has a distal end in an acute angle shape. The sway member is a balance member and includes a concave cavity defined in a top end thereof to accommodate the support post and to be pushed by the detail end of the second segment of the support post, thus forming balanced and light-weight effect. The sway member also including a fixing portion formed on a top end thereof and a permanent magnet disposed on a side thereof, the connecting object is replaceably fixed into the fixing portion of the sway member.

A power unit includes an optical signal apparatus and a magnetic field generator, the optical signal apparatus is comprised of at least one photoresistor and at least one illumining member for illuminating lights at changeable luminous intensity. The magnetic field generator includes at least one electromagnetic force coil electrically mounted on a lower side of the permanent magnet of the swinging unit. The at least one electromagnetic force coil pushes the permanent magnet on the sway member after the at least one photoresistor controls magnetic fields at different strengths, the sway member swings at a predetermined amplitude; and a light source is fixed on one side of the connecting object for illuminating lights to the connecting object.

### BRIEF DESCRIPTION OF THE DRAWINGS

FIG. 1 is a perspective view showing the exploded components of a railless frequency-conversing swing device according to a preferred embodiment of the present invention.

FIG. 2 is a perspective view showing the assembly of the railless frequency-conversing swing device according to the preferred embodiment of the present invention.

FIG. 3 is a cross sectional view showing the assembly of the railless frequency-conversing swing device according to the preferred embodiment of the present invention.

FIG. 4 is a perspective view showing an application of the railless frequency-conversing swing device according to the preferred embodiment of the present invention.

FIG. 5 is another perspective view showing the application of the railless frequency-conversing swing device according to the preferred embodiment of the present invention.

FIG. 6 is a side plan view showing another application of the railless frequency-conversing swing device according to the preferred embodiment of the present invention.

FIG. 7 is a side plan view showing another application of the railless frequency-conversing swing device according to the preferred embodiment of the present invention.

FIG. 8 is a side plan view showing another application of the railless frequency-conversing swing device according to the preferred embodiment of the present invention.

FIG. 9 is a cross sectional view showing the operation of the railless frequency-conversing swing device according to the preferred embodiment of the present invention.

FIG. 10 is another cross sectional view showing the operation of the railless frequency-conversing swing device according to the preferred embodiment of the present invention.

FIG. 11 is a perspective view showing another application of the railless frequency-conversing swing device according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

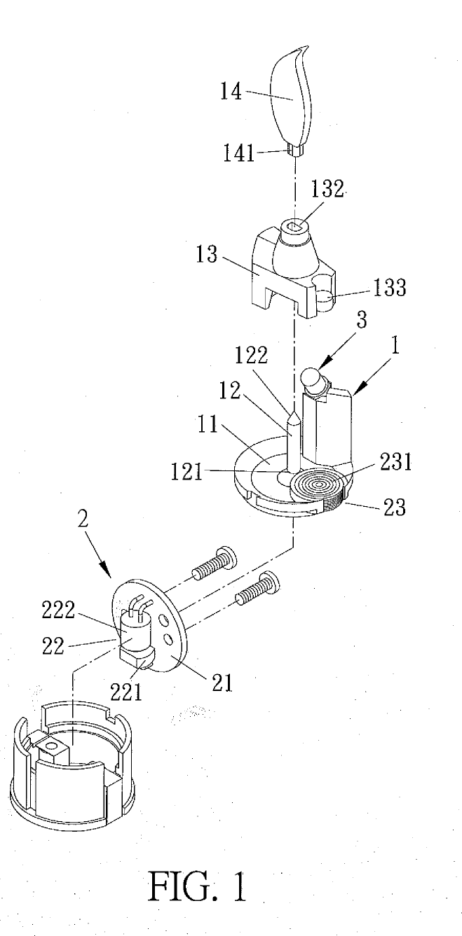

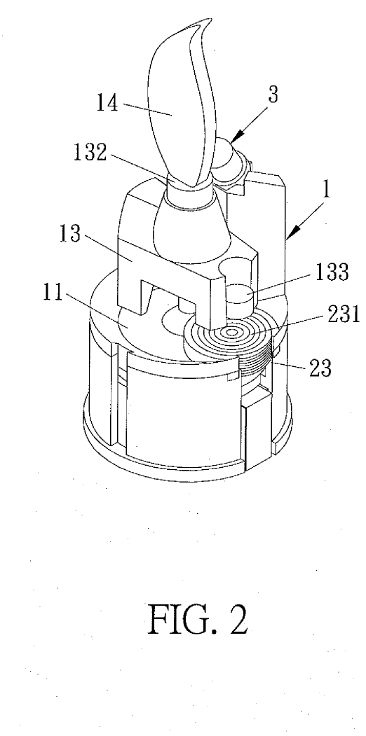

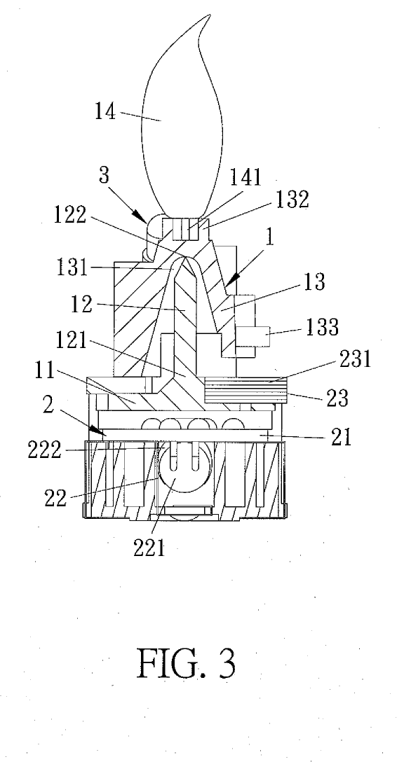

With reference to FIGS. 1-3, a railless frequency-conversing swing device according to a preferred embodiment of the present invention comprises: a swinging unit 1, a power unit 2, and a light source 3.

The swinging unit 1 includes a base 11, a support post 12, a sway member 13, and a connecting object 14. The base 11 is formed in a circular sheet shape, the support post 12 includes a first segment 121 and a second segment 122, and the first segment 121 is vertically connected with the base 11, the second segment 122 and the first segment 121 are located at a straight axis and above or on the base 11, the second segment 122 has a distal end in an acute angle shape. The sway member 13 is a balance member and includes a concave cavity 131 defined in a top end thereof to accommodate the support post 12 and to be pushed by the detail end of the second segment 122 of the support post, the sway member 13 also includes a fixing portion 132 formed on a top end thereof and a permanent magnet 133 disposed on a first side thereof, the sway member 13 further includes a second side weighted to balance the support post 12. The connecting object 14 is in a flame sheet shape and includes an inserting portion 141 arranged on a lower end thereof to changeably insert into the fixing portion 132 of the sway member 13.

The power unit 2 includes a circuit board 21, an optical signal apparatus 22, and a magnetic field generator 23. The circuit board 21 is a printed circuit board (PCB) fixed on a lower side thereof and electrically connected with a first power cable (not shown), the optical signal apparatus 22 is arranged on a bottom surface of the circuit board 21 and electrically connected with the circuit board 21, and the optical signal apparatus 22 is comprised of at least one photoresistor 221 and at least one illumining member 222 for illuminating lights at changeable luminous intensity. The at least one illumining member 222 is a light-emitting diode (led) for illuminating glitters or lights at changeable luminous intensity. In this embodiment, there are one photoresistor 221 and one illumining member 222 provided. The magnetic field generator 23 includes at least one electromagnetic force coil 231 electrically connected with a second power cable (not shown). In this embodiment, there is one electromagnetic force coil 231 mounted on the base 11 of the swinging unit 1 to correspond to the permanent magnet 133 of the sway member 13.

The light source 3 is fixed on one side of a lower end of the connecting object 14 and is light-emitting diode (led) for illuminating lights to the connecting object 14, thus brightening the connecting object 14.

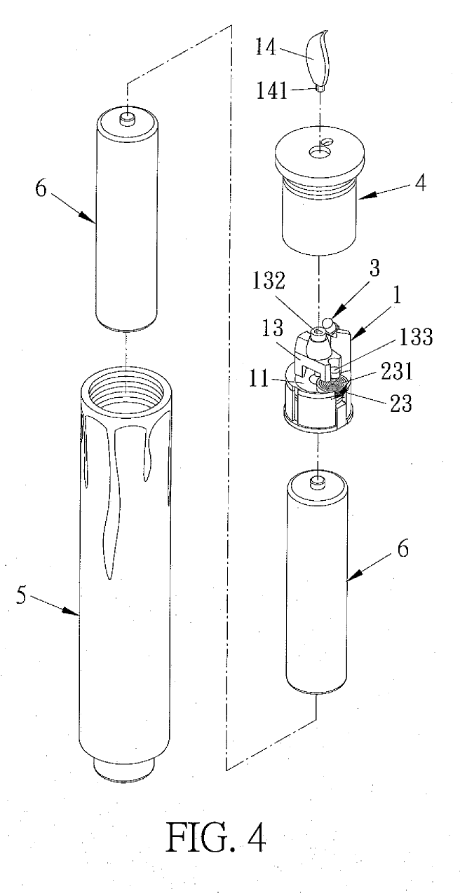

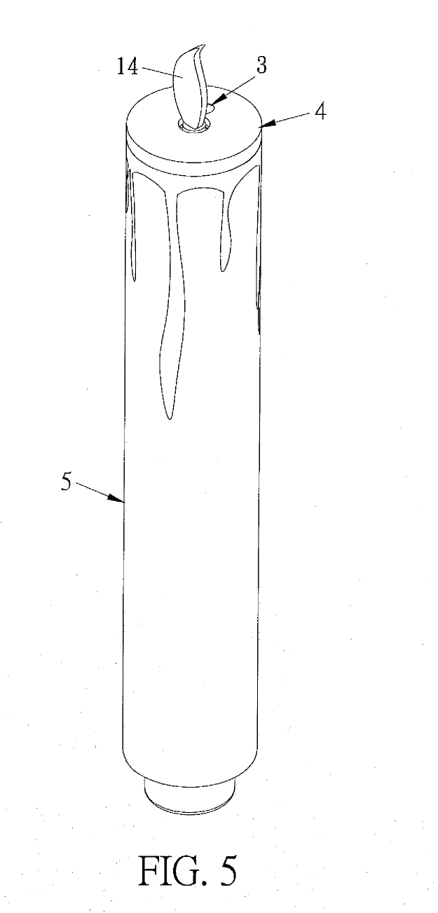

Referring further to FIGS. 4 and 5, in application, the railless frequency-conversing swing device is fixed in a housing 4, the connecting object 14 is mounted on a top end of the housing 4, and the housing 4 and the railless frequency-conversing swing device are fixed in an opening 51 on one end of a cylindrical column 5, the cylindrical column 5 includes a cylindrical battery 6 secured therein to supply power, thus assembling a simulation candle.

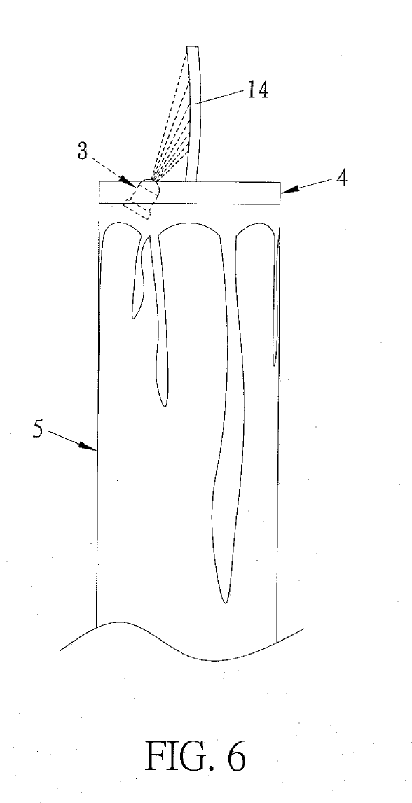

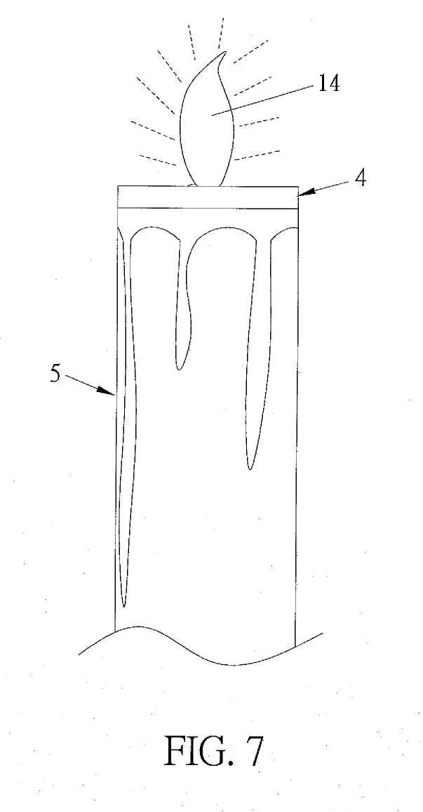

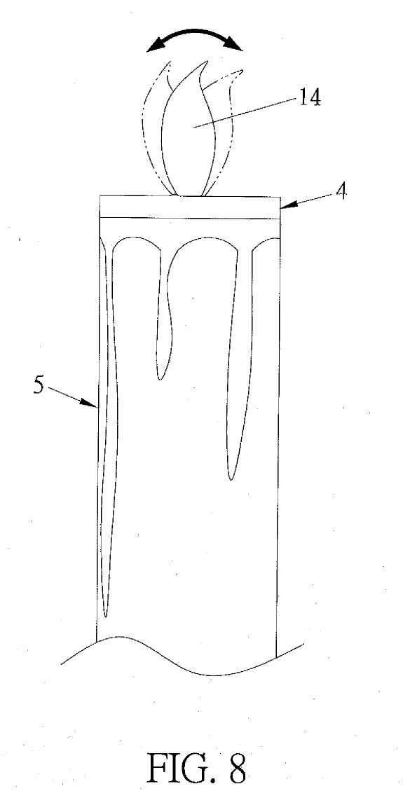

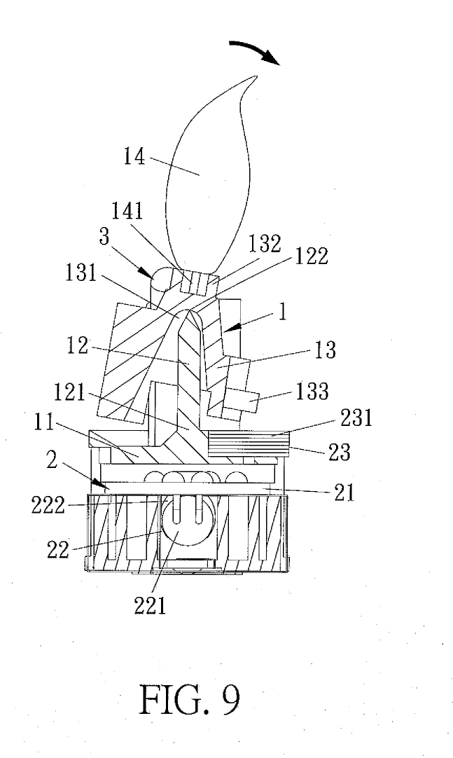

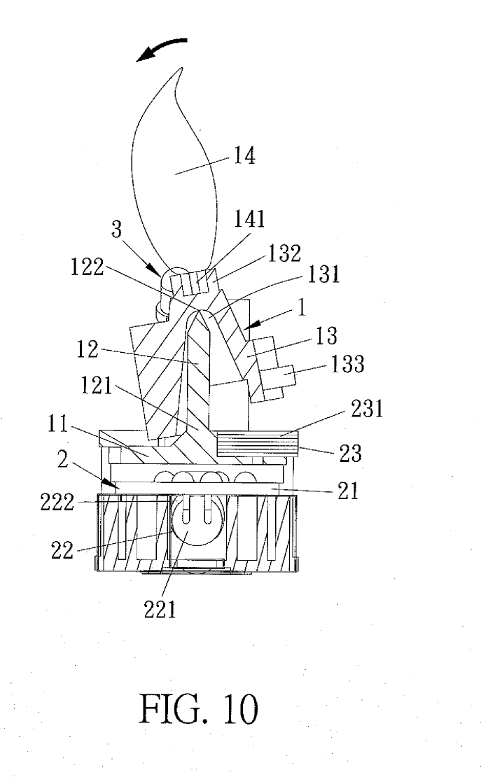

In use, the cylindrical battery 6 supplies power, as shown in FIGS. 6-10, and the light source 3 illuminates the connecting object 14 directly, the at least one illumining member 222 of the optical signal apparatus 22 of the power unit 2 illuminates irregular lights (such as illuminating glitters or lights at changeable luminous intensity), and the at least one photoresistor 221 receives the irregular lights and converts the irregular lights into impedances of various intensities Hence, the impedances act on the first power cable which electrically connects with the at least one photoresistor 221, and the electric currents of the first power cable increases or decreases so that the second power cable electrically connecting with the at least one electromagnetic force coil 231 produces magnetic fields at different strengths to push the permanent magnet 133 on the sway member 13, and the sway member 13 swings at different amplitudes and frequencies along the distal end of the second segment 122 of the support column 12, accordingly the connecting object 14 swings to cause flame-like effect.

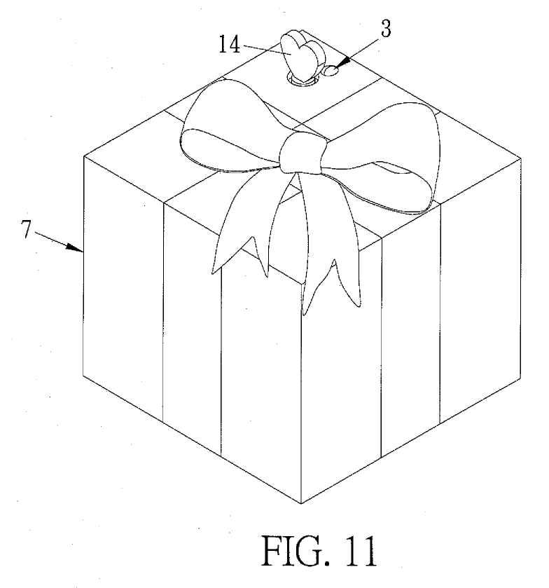

Preferably, the connecting object 14 is in other shapes, for example, as illustrated in FIG. 11, the connecting object 14 is in a heart shape. Furthermore, the connecting object 14 is in any one of an insect shape, an animal shape, a plant shape, a character shape, a landscape shape and geometry shape. Preferably, the railless frequency-conversing swing device is supplied power by the cylindrical battery 6, a button cell battery or an external power supply. The railless frequency-conversing swing device is fixed on a gift box 7 as shown in FIG. 11 or a case (not shown) made of various materials and having an outer surface coupled with the connecting object 14 to cause flame-like effect.

Thereby, the railless frequency-conversing swing device has advantages as follows:

1. The railless frequency-conversing swing device captures optical signals at different strengths to control oscillating frequency, and the concave cavity 131 is defined in the top end of the sway member 13 to accommodate the support post 12 and to be pushed by the detail end of the second segment 122 of the support post 12, thus assembling the sway member 13 easily. In addition, the sway member 13 swings freely and smoothly at minimum friction by using magnetic force and physical inertia.

2. The railless frequency-conversing swing device comprises the power unit 2, and the at least one photoresistor 221 of the optical signal apparatus 22 of the power unit 2 receives the irregular lights from the at least one illumining member 222 and generates different signals to control the magnetic fields at different strengths so as to further to push the permanent magnet 133 on the sway member 13, and the sway member 13 swings at different amplitudes and frequencies. In other words, by using magnetic theory, physics friction theorem and simplified electronic circuits, the sway member 13 swings at changeable oscillating frequencies, thus changing oscillating frequencies, simplifying electronic components, avoiding consumption of electric circuit, lowering power consumption, and eliminating inconvenience of battery replacement.

While various embodiments in accordance with the present invention have been shown and described, it is clear to those skilled in the art that further embodiments may be made without departing from the scope of the present invention.

What is claimed is:

1. A railless frequency-conversing swing device comprising:
a swinging unit including a base, a support post, a sway member, and a connecting object; the support post including a first segment and a second segment, and the first segment being vertically connected with the base, the second segment having a distal end in an acute angle shape; the sway member being a balance member and including a concave cavity defined in a top end thereof to accommodate the support post and to be pushed by the detail end of the second segment of the support post, the sway member also including a fixing portion formed on a top end thereof, the connecting object being replaceably fixed into the fixing portion of the sway member to swing with the sway member; and a light source fixed on one side of the connecting object for illuminating lights to the connecting object.

2. The railless frequency-conversing swing device as claimed in claim 1, wherein the connecting object includes an inserting portion arranged on a lower end thereof to changeably insert into the fixing portion of the sway member.

3. The railless frequency-conversing swing device as claimed in claim 1 further comprising a case for accommodating the base, the support post, the sway member, and the connecting object of the swinging unit, and the connecting object is coupled with an outer surface of the case.

4. A railless frequency-conversing swing device comprising:
a swinging unit including a base, a support post, a sway member, and a connecting object; the support post including a first segment and a second segment, and the first segment being vertically connected with the base, the second segment having a distal end in an acute angle shape; the sway member being a balance member and including a concave cavity defined in a top end thereof to accommodate the support post and to be pushed by the detail end of the second segment of the support post, thus forming balanced and light-weight effect; the sway member also including a fixing portion formed on a top end thereof and a permanent magnet disposed on a side thereof, the connecting object being replaceably fixed into the fixing portion of the sway member;
a power unit including an optical signal apparatus and a magnetic field generator, the optical signal apparatus being comprised of at least one photoresistor and at least one illumining member for illuminating lights at changeable luminous intensity; the magnetic field generator including at least one electromagnetic force coil electrically mounted on a lower side of the permanent magnet of the swinging unit; the at least one electromagnetic force coil pushing the permanent magnet on the sway member after the at least one photoresistor controls magnetic fields at different strengths, the sway member swinging at a predetermined amplitude; and a light source fixed on one side of the connecting object for illuminating lights to the connecting object.

5. The railless frequency-conversing swing device as claimed in claim 4, wherein the connecting object includes an inserting portion arranged on a lower end thereof to changeably insert into the fixing portion of the sway member.

6. The railless frequency-conversing swing device as claimed in claim 4 further comprising a case for accommodating the base, the support post, the sway member, and the connecting object of the swinging unit, and the connecting object is coupled with an outer surface of the case.

7. The railless frequency-conversing swing device as claimed in claim 4, wherein the at least one illumining member of the power unit is a light-emitting diode (led) for illuminating glitters or lights at changeable luminous intensity.
